(19) United States
(12) Patent Application Publication
(10) Pub. No.: US 2012/0247099 A1
(43) Pub. Date: Oct. 4, 2012

(54) MASTER CYLINDER

(75) Inventors: Takafumi Omune, Kariya-shi (JP); Koji Suzuki, Nagoya-shi (JP)

(73) Assignee: ADVICS CO., LTD., Kariya-city (JP)

(21) Appl. No.: 13/436,137

(22) Filed: Mar. 30, 2012

(30) Foreign Application Priority Data
Mar. 31, 2011 (JP) 2011-078554

(51) Int. Cl. F15B 7/00

(52) U.S. Cl. 60/533

(57) ABSTRACT

A master cylinder includes a cylinder body formed with an annular concave portion at a position surrounding a space where a piston is inserted so as to fit in the cylinder body. An annular cup seal is provided in the annular concave portion and includes an inner lip portion coming into sliding contact with the outer periphery of a piston, an outer lip portion provided on the outside thereof, and a base portion arranged along a first inner wall surface of the annular concave portion. The cup seal further includes a plurality of projecting portions coming into abutment with a second inner wall surface of the annular concave portion. Clearance areas are formed between the first inner wall surface and the base portion at positions opposing the abutting portions between the projecting portions and the second inner wall surface.

### CROSS REFERENCE TO RELATED APPLICATION

This application is based on and claims priority under 35 U.S.C. §119 to Japanese Patent Application 2011-078554, filed on Mar. 31, 2011, the entire content of which is incorporated herein by reference.

### TECHNOLOGICAL FIELD

The present invention relates to a master cylinder including a cup seal.

BACKGROUND DISCUSSION

A known master cylinder is disclosed in JP-A-2009-56922 and JP-A-2009-61849. This master cylinder includes a cylinder body formed with an annular concave portion at a position surrounding a space where a piston is inserted so as to fit in the cylinder body, the piston being formed with a communication hole configured to communicate a pressure chamber in the interior of the piston and a reservoir on the outside of the piston; an annular cup seal provided in the annular concave portion and configured to be fitted on the piston so as to be capable of moving relatively with respect to the piston, the cup seal being provided at a position closing the communication hole in association with actuation of the piston at the time of a braking operation.

In JP-A-2009-56922, a cup seal integrally includes an inner lip portion coming into sliding contact with a piston, an outer lip portion arranged on the outer peripheral side thereof, and a base portion coupling the inner lip portion and the outer lip portion, and is molded into an angular C-shape in cross section.

In JP-A-2009-56922, the piston includes an annular concave portion having a triangular shape in cross section formed on an outer periphery of the piston by two tapered surfaces, the inner lip of the cup seal is formed with two tapered surfaces so as to fit in the concave portion in the inner periphery thereof and, in addition, the inner lip of the cup seal is formed with a projection for positioning at the distal end side thereof. From this configuration, when the cup seal is fitted into the annular concave portion, the tapered surface of the piston and the tapered surface of the inner lip come into press contact with each other when the piston moves forward, and the projection is held in abutment with the inner surface of the annular concave portion, so that the displacement of the cup seal is restricted and an invalid stroke is inhibited.

In JP-A-2009-61849, a cup seal integrally includes an inner lip portion (an inner peripheral lip in the document) coming into sliding contact with a piston, an outer lip portion (an outer peripheral lip in the document) arranged on the outer peripheral side, and a base portion (a base portion in the document) coupling the inner lip portion and the outer lip portion, and is molded into an angular C-shape in cross section.

In JP-A-2009-61849, a plurality of resilient projecting strips are formed so as to project from a distal end of the base portion on the outer peripheral side to the bottom side of a cylinder hole at regular intervals in the circumferential direction, and the length of projection of the resilient strips is set so that the resilient projecting strips come into abutment with the inner surface of the annular concave portion in a bent state in a state of being fitted into an annular concave portion (a seal groove in the document).

The cup seal having the projection and the resilient projecting strips as described in JP-A-2009-56922 and JP-A-2009-61849 is configured in such a manner that the projections and the resilient projecting strips come into abutment with the inner wall of the annular concave portion to restrict the displacement of the cup seal, so that the displacement of the cup seal is restricted and the inhibition of the invalid stroke is realized when the piston is moved.

However, the configuration in which the projection and the resilient projecting strips are formed on the cup seal is effective for inhibiting the invalid stroke but, on the other hand, requires accuracy in projecting amount of the projection and the resilient projecting strips. In particular, when the projecting amount is longer than a predetermined length (designed length), the cup seal can hardly be inserted into the annular concave portion, which may pose a problem for assembly of the master cylinder. Also, in the configuration in which the projection and the resilient projecting strips are formed on the cup seal of this type, in addition to the posing of the problem for the assembly of the master cylinder, there is a case where followability of the cup seal against the disturbance such as oscillations of the piston is deteriorated, and the sealing failure of the cup seal may be generated.

### SUMMARY OF THE INVENTION

It is an object of the invention to configure a master cylinder which allows easy assembly even when the projecting amount is longer than a preset length without destroying a favorable surface of a cup seal where a projecting portion is formed and achieves improvement of sealing properties against the disturbance such as oscillations of the piston in a rational manner.

In order to achieve this objective, there is provided an improved master cylinder includes a cylinder body formed with an annular concave portion at a position surrounding a space where a piston is inserted so as to fit therein, the piston being formed with a communication hole configured to communicate a pressure chamber in the interior of the piston and a reservoir on the outside of the piston; an annular cup seal configured to be fitted on the piston so as to be capable of moving relatively with respect to the piston and provided in the annular concave portion, and the cup seal being provided at a position closing the communication hole in association with the actuation of the piston at the time of a braking operation, wherein the annular concave portion includes a first inner wall surface on the upstream side in the direction of actuation of the master cylinder at the time of the braking operation, and a second inner wall surface opposing thereto, the cup seal integrally includes: an inner lip potion coming into sliding contact with the piston, an outer lip portion arranged on the outer peripheral side of the annular concave portion, and a base portion arranged along the first inner wall surface, and is formed with projecting portions coming at projecting ends thereof into abutment with the second inner wall surface at a plurality of positions in the circumferential direction of the cup seal, and the cup seal is provided in the annular concave portion in a mode in which clearance areas are formed between the first inner wall surface and the base portion at positions opposing abutting positions between the projecting portions and the second inner wall surface in a state in which the projecting portions are brought into abutment with the second inner wall surface and part of the base portion is brought into abutment with the first inner wall surface as an abutment area.

In this configuration, in a state in which the cup seal is inserted into the annular concave portion, the projecting portions come into abutment with the second inner wall surface in a state in which part of the base portion is in abutment with the first inner wall portion, so that the cup seal is not displaced in the interior of the annular concave portion even when the piston is in operation, so that occurrence of an invalid stroke is inhibited. Also, for example, when fitting the cup seal having the projecting portions projecting by an amount longer than the preset length into the annular concave portion, the projecting portions come into abutment with the second inner wall surface and the base portion is displaced in the direction of the first inner wall surface by a pressing force generated by this abutment. However, since the displacement is directed toward the clearance range, even though the base portion is displaced toward the clearance range, the clearance range absorbs the displacement, so that a problem that the base portion corresponding to the projecting portions comes into contact with the first inner wall surface is resolved. Accordingly, even though the projecting amount of the projecting portions is longer than a designed length, the cap seal can be fitted easily into the annular concave portion. Consequently, the master cylinder which allows easy assembly even when the projecting amount is longer than the preset length without destroying a favorable surface of the cup seal where the projecting portion is formed.

### BRIEF DESCRIPTION OF THE DRAWINGS

FIG. 1 is a cross-sectional view of a master cylinder;

FIG. 2 is a cross-sectional view of an annular concave portion and a primary cup;

FIG. 3 is a perspective view of the primary cup; and

FIG. 4 is a cross-sectional view of the annular concave portion and the primary cup according to another embodiment (a).

### DETAILED DESCRIPTION OF THE EMBODIMENTS

Referring now to the drawings, an embodiment of the invention will be described.

### General Configuration

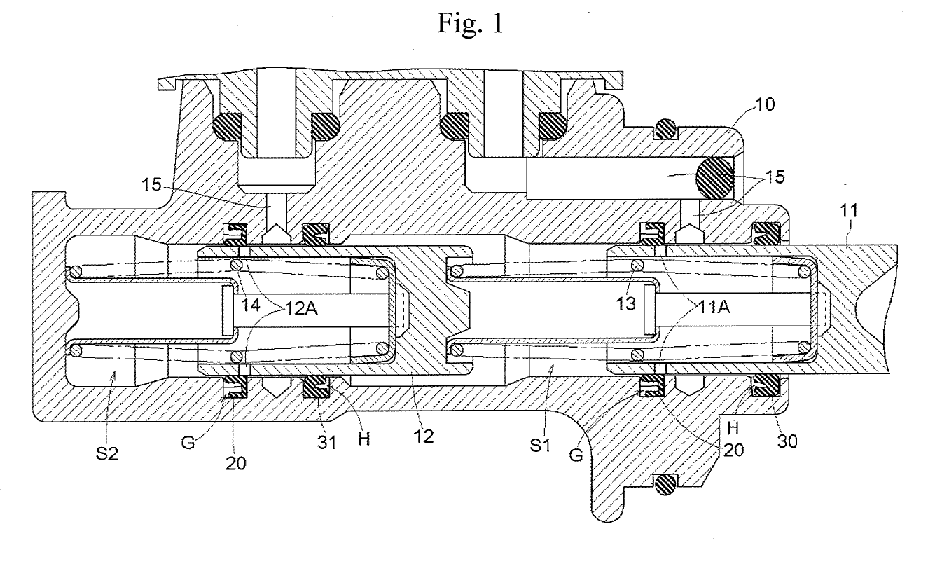

As shown in FIG. 1, a tandem-type master cylinder according to the invention includes, for example, a first piston 11 and a second piston 12 fitted in a cylinder-shaped space formed in a cylinder body 10 so as to be capable of sliding freely therein, and a first return spring 13 and a second return spring 14 which restore the first piston 11 and the second piston 12 to a non-operating position. An oil channel 15 is formed between a first pressure chamber S1 and a reservoir (not shown) to which the pressure from the first piston 11 is applied. The oil channel 15 is formed between a second pressure chamber S2 and the reservoir to which a pressure from the second piston 12 is applied, and rubber-made primary cups 20 (an example of cup seal) to be fitted on the first piston 11 and the second piston 12 are provided. The first piston 11 includes a rubber-made secondary cup 30, and the second piston 12 includes a rubber-made pressure cup 31.

The master cylinder is configured in such a manner that the first piston 11 and the second piston 12 are maintained at positions shown in FIG. 1 when a brake pedal (not shown) is in a non-operating state, and the first pressure chamber S1 and the second pressure chamber S2 communicate with the oil channel 15. When the brake pedal is pressed down, the first piston 11 and the second piston 12 are moved in the direction compressing the first return spring 13 and the second return spring 14 against urging forces thereof (left side in the drawing) so that pressures in the first pressure chamber S1 and the second pressure chamber S2 are increased, so that a pressure of oil is applied to a braking apparatus. Although not shown in the drawings, an output port configured to supply oil pressurized at the time of increase in pressures in the first pressure chamber S1 and the second pressure chamber S2 to the braking apparatus is formed independently on the cylinder body 10.

In the tandem-type master cylinder, the second piston 12 is arranged coaxially with the first piston 11 in the interior of the cylinder-shaped space, and part of the first piston 11 is exposed to the outside of the cylinder body 10. A booster or the like which transmits an operating force of the brake pedal is coupled to this, exposed portion. The first pressure chamber S1 is formed between the first piston 11 and the second piston 12 in the interior of the cylinder-shaped space, and the above-described first return spring 13 is provided at a position interposed between the first piston and the second piston in the interior of the first pressure chamber S1. The second pressure chamber S2 is formed between the second piston and the cylinder body 10 in the interior of the cylinder-shaped space, and the second return spring 14 is provided at a position where an urging force is applied to the above-described second piston 12 in the interior of the second pressure chamber S2.

The first piston 11 is formed with a cylindrical portion which envelopes the first pressure chamber S1 therein and a plurality of first communicating holes 11A are formed in the cylindrical portion at a plurality of positions in the circumferential direction so as to penetrate therethrough in the radial direction. In the same manner, the second piston 12 is formed with a cylindrical portion which envelopes the second pressure chamber S2 therein and a plurality of second communicating holes 12A are formed in the cylindrical portion at a plurality of positions in the circumferential direction so as to penetrate therethrough in the radial direction.

Formed at positions surrounding the cylinder-shaped space in the vicinity of the first communicating holes 11A and the second communicating holes 12A are annular concave portions G and the above-described primary cups 20 are fitted into the annular concave portions G. Also, formed at a position surrounding the cylinder-shaped space in the vicinity of the cylinder-shaped space and at a position surrounding the cylinder-shaped space which accommodates the second piston 12 on the side of the first piston with respect to the oil channel 15 are annular seal grooves H. The secondary cup 30 is fitted into one of the seal grooves H, and the pressure cup 31 is fitted into the other one of the seal grooves H.

The secondary cup 30 blocks oil from leaking out from the cylinder body, and blocks entry of the outside air. The pressure cup 31 blocks the oil from leaking between the first pressure chamber, S1 and the second pressure chamber S2.

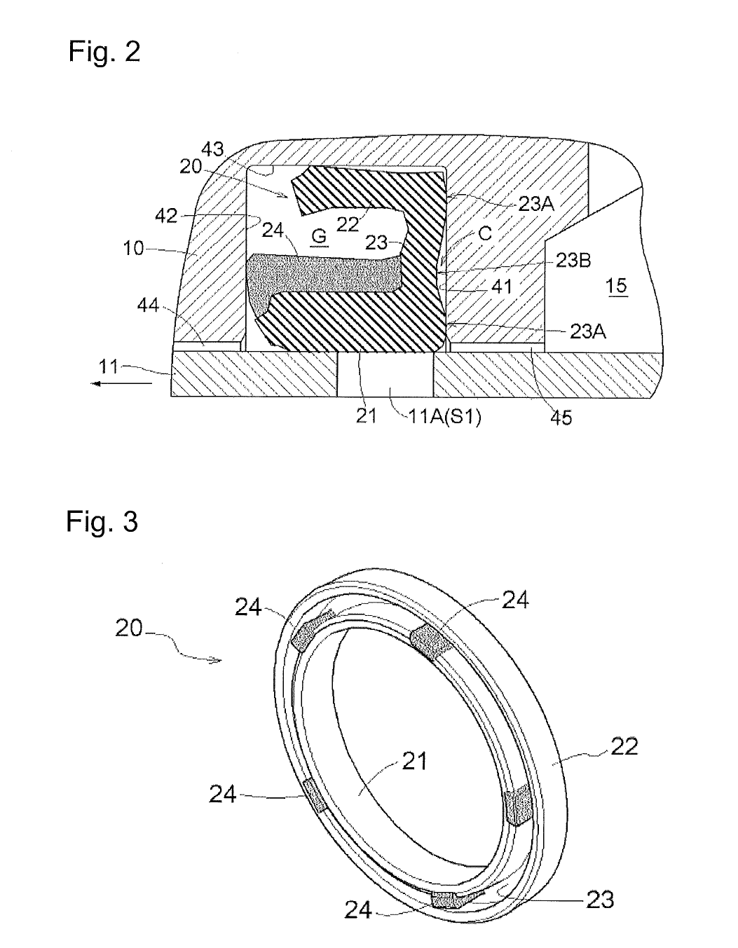

As shown in FIG. 2, the annular concave portion G includes a first inner wall surface 41 on the upstream side in the direction of movement of the master cylinder at the time of a braking operation, a second inner wall surface 42 opposing thereto, and a third inner wall surface 43 on the outer peripheral side thereof, and is formed into a square shape in cross section. The first inner wall surface 41 and the second inner wall surface 42 are formed as flat surfaces orthogonal to an axial center of the cylinder-shaped space, and the third inner wall surface 43 is formed on the circumference about the axial center thereof. A communicating wall 44 which communicates the first pressure chamber S1 of the cylinder-shaped space and the annular concave portion G is formed and a communicating channel 45 is formed between the first inner wall surface 41 of the cylinder-shaped space and the oil channel 15 in a groove-shape. In particular, when the brake pedal (not shown) is in the non-operating state, the first pressure chamber S1 communicates with the oil channel 15 via the first communicating holes 11A and the communicating channel 45 and, in the same manner, the second pressure chamber S2 communicates with the oil channel 15 via the second communicating holes 12A and the communicating channel 45.

When the master cylinder is in the non-operating state, the primary cups 20 of the first piston 11 create a state in which the first pressure chamber S1 communicates with the oil channel 15 via the first communicating holes 11A and the communicating channel 45 and, in the same manner, a state in which the second pressure chamber S2 communicates with the oil channel 15 via the second communicating holes 12A and the communicating channel 45. Then, as shown in FIG. 2, at the time of the braking operation, the primary cups 20 close the first communicating holes 11A in association with the operation of the first piston 11. In the same manner, the primary cups 20 close the second communicating holes 12A in association with the actuation of the second piston 12.

Since the primary cups 20 of the first piston 11 and the primary cups 20 provided on the second piston 12 have the same configuration and have the same function, the configuration of the primary cups 20 provided on the first piston 11 will be described in detail.

### Primary Cup

As shown in FIG. 2 and FIG. 3, the primary cup 20 is formed of a rubber material which is flexibly deformable, and integrally includes an inner lip portion 21 which comes into sliding contact with the outer periphery of the first piston 11, an outer lip portion 22 arranged on the third inner wall surface 43 (the outer peripheral side) of the annular concave portion G, and a base portion 23 arranged along the first inner wall surface 41 so as to form an angular C shape in cross-section.

The primary cup 20 is formed at a plurality of positions (five positions) in the circumferential direction thereof with projecting portions 24 which come into abutment with the second inner wall surface 42 at protruded ends thereof in a state of being fitted into the annular concave portion G, and is formed with clearance areas C between the first inner wall surface 41 and the base portion 23 at positions opposing an abutment positions between the projecting portions 24 and the second inner wall surface 42 in a state in which the projecting portions 24 are in abutment with the second inner wall surface 42 and abutment areas 23A formed at two positions on the outer peripheral side and the inner peripheral side of the base portion 23 are in abutment with the first inner wall surface 41.

In other words, when imagining an imaginary straight line parallel to the axial center of the cylinder-shaped space from among imaginary lines passing through positions where the projecting portions 24 are in abutment with the second inner wall surface 42, the clearance areas C are formed in an area including a point of intersection of the imaginary straight line with the first inner wall surface 41. For reference, it is also possible to form depressed portions 23B by the same number as the projecting portions 24 as the clearance areas C, but in the configuration shown in FIG. 2, the depressed portion 23B located at the midpoint between the abutment areas 23A formed at two positions on the outer peripheral side and the inner peripheral side of the base portion 23 are formed in a ring shape having a center at the axial center of the cylinder-shaped space. As a matter of course, the abutment areas 23A located at two positions are formed at positions different from the depressed portion 23B.

The clearance range C allows easy fitting when fitting the primary cup 20 into the annular concave portion G even though, for example, the projecting amount of the projecting portions 24 are longer than the preset length (the designed length) due to the manufacturing error. More specifically, when fitting the primary cup 20 having the projecting portions 24 projecting by an amount longer than the preset length into the annular concave portion G, the projecting portions 24 come into abutment with the second inner wall surface 42 and the base portion 23 is displaced in the direction of the first inner wall surface 41 by a pressing force generated by this abutment. However, in the case of the primary cup 20 of the invention, since the direction of the displacement is a direction toward the clearance range C, the displacement is absorbed by the clearance range C. Accordingly, a problem caused by the base portion 23 projecting toward the first inner wall surface 41 is reduced and a problem caused by the contact of the base portion 23 with respect to the first inner wall surface 41 is inhibited, so that the fitting is facilitated.

The projecting portions 24 are integrally formed with the inner lip portion 21 as protruding portions formed on a surface of the inner lip portion 21 opposing the outer lip portion 22 so as to protrude therefrom. The projecting portions 24 may have a configuration to extend upright from the base portion 23 in a mode separate from the inner lip portion 21.

The inner lip portion 21 has an inner diameter which allows tight-fitting with respect to the outer periphery of the first piston 11 so as to be movable relative to each other, and the dimension extending from the base portion 23 to an extending end portion on the opposite side (an end portion on the side of the second inner wall surface, an end portion on the left side in FIG. 2) is set to a dimension slightly shorter than the distance between the first inner wall surface 41 and the second inner wall surface 42 of the annular concave portion G, so that the extending end portion is slightly separated from the second inner wall surface 42.

The outer lip portion 22 has an extending dimension from the base portion 23 to an extending end potion on the opposite side (the end portion on the side of the second inner wall surface, the end portion on the left side in FIG. 2) shorter than the dimension of an extending end of the inner lip portion 21, so that the extending end portion is significantly separated from the second inner wall surface 42. Also, a portion of the outer lip portion 22 near an end portion thereof on the side of the extending end portion is in contact with the third inner wall surface 43, and an area on the side of the extending end portion with respect to this contact position and an area on the side of the base portion 23 from the position of the contact end portion are separated from the third inner wall surface 43.

### Actuation of First Piston

In this configuration, when the brake pedal is pressed downward, the first piston 11 is moved leftward in FIG. 1. In association with this movement, the inner lip portion 21 of the primary cup 20 closes the first communicating holes 11A, the internal pressure in the first pressure chamber S1 is increased and this pressure is applied to the braking apparatus from the output port.

In this manner, when the first piston 11 is moved leftward in FIG. 1 and FIG. 2, a moving force is applied to the entirety of the primary cup 20 due to a frictional force applied between the first piston 11 and the inner lip portion 21. However, since the abutment areas 23A of the base portion 23 are in abutment with the first inner wall surface 41, the movement of the primary cup 20 is reduced, and hence the first communicating holes 11A are quickly closed.

In this manner, when the first communicating holes 11A reach a closing state and the pressure in the first pressure chamber S1 is increased, the pressure from the first pressure chamber S1 is applied to the annular concave portion G from the communicating wall 44. This pressure is applied to the extending end portion of the inner lip portion 21 to a space between the inner lip portion 21 and the outer lip portion 22, and presses the base portion 23 against the first inner wall surface 41 and, simultaneously, presses the inner lip portion 21 against the outer peripheral surface of the first piston 11 and thus the outer lip portion 22 against the third inner wall surface 43. Consequently, a flow of oil from the first pressure chamber S1 to the oil channel 15 is blocked and good sealing properties are maintained and, consequently, the braking operation which does not cause the invalid stroke is realized.

When the braking operation is released thereafter, the first piston 11 is actuated in the non-operating direction by the urging forces applied by the first return spring 13 and the second return spring 14 and, at the time of the actuation of the first piston 11, the oil from the braking apparatus is returned to the first pressure chamber S1 and, simultaneously, a pressure difference of the oil between the first pressure chamber S1 and the oil channel 15 is applied to the annular concave portion G from the communicating channel 45. By the application of the pressure from the communicating channel 45 in this manner, a gap which allows the oil to flow is formed between the base portion 23 and the first inner wall surface 41 and, in addition, by the pressure of the oil from this gap, a gap which allows the oil to flow is formed between the outer lip portion 22 and the third inner wall surface 43, and the oil flowed from these gaps flow from a space between the extending end portion of the inner lip portion 21 and the second inner wall surface 42 into the communicating wall 44, whereby the returning action of the first piston 11 is accelerated.

### Other Embodiments

Other embodiments will be described below. In these embodiments, parts having the same functions as those in the embodiment described above are designated by common numerals and symbols to those in the embodiment described above.

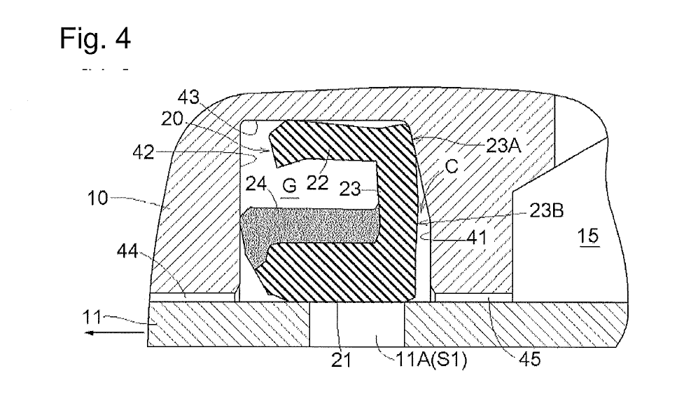

(a) As shown in FIG. 4, the first inner wall surface 41 is formed into an inclined surface which is inclined to separate from the second inner wall surface 42 as it approaches the first piston 11 and the the outer peripheral portion of the base portion 23 located on the outer peripheral side is brought into abutment with the first inner wall surface 41 as the abutment areas 23A, whereby the clearance range C is formed between the base portion 23 and the first inner wall surface 41 on the inner peripheral side of the base portion 23 with respect to the outer peripheral portion. In FIG. 4, only part of the first inner wall surface 41 is formed into an inclined surface, the entire surface of the first inner wall surface 41 may be formed as a tapered inclined surface. Alternatively, although the base portion 23 may be shaped into a posture orthogonal to the axial center of the cylinder-shaped space, the configuration shown in FIG. 4 is formed with the slightly inclined surface extending along the posture parallel to the first inner wall surface 41 on the outer peripheral side of the base portion 23.

In this configuration, even though the depressed portion 23B is not formed on the base portion 23 of the primary cup 20, the clearance range C can be formed between the first inner wall surface 41 at a position opposing the abutting position between the projecting portions 24 and the second inner wall surface 42 and the base portion 23 in a state in which the abutment areas 23A on the outer peripheral side of the base portion 23 abut against the first inner wall surface 41.

(b) Although the configuration is similar to the configuration described in (a), the first inner wall surface 41 is formed as a flat surface orthogonal to the axial center of the cylinder-shaped space and causes the outer peripheral portion of the base portion 23 to come into abutment with the first inner wall surface 41 as the abutment areas 23A, and an inclined surface approaching the second inner wall surface 42 as it goes toward the inner peripheral side of the base portion 23 is formed so that the inner peripheral side of the base portion 23 is separated from the first inner wall surface 41. Accordingly, the clearance range C is formed between the base portion 23 and the first inner wall surface 41 on the inner peripheral side of the base portion 23 with respect to the outer peripheral portion.

(c) The first inner wall surface 41 is formed as a flat surface orthogonal to the axial center of the cylinder-shaped space and causes the inner peripheral portion of the base portion 23 to come into abutment with the first inner wall surface 41 as the abutment areas 23A, and the inclined surface approaching the second inner wall surface 42 as it goes toward the outer peripheral side of the base portion 23 is formed so that the outer peripheral side of the base portion 23 is separated from the first inner wall surface 41, whereby the clearance range C is formed between the base portion 23 and the first inner wall surface 41 on the inner peripheral side of the base portion 23 with respect to the outer peripheral portion. Although this configuration is obtained by inverting the position of the abutment areas 23A between the inner and outer sides from the configuration described in (b) shown above, the clearance range C which is the same as that in the configuration described in (b) is formed.

### Advantages and Effects of Embodiment and Other Embodiment

In this manner, in the master cylinder of the invention, in the state in which the primary cup 20 (cup seal) is inserted into the annular concave portion G, the projecting portions 24 are in abutment with the second inner wall surface 42 in a state in which part of the base portion 23 is in abutment with the first inner wall surface 41. Accordingly, the displacement of the primary cup 20 is inhibited in the interior of the annular concave portion G even when the piston is actuated. Accordingly, occurrence of the invalid stroke is inhibited.

Also, by forming the clearance range C, the fitting is facilitated even though the projecting amounts of the projecting portions 24 are longer than the preset length (the designed length) due to the manufacturing error. More specifically, although the projecting portions 24 come into abutment with the second inner wall surface 42 and the base portion 23 is displaced in the direction of the first inner wall surface 41 by the pressing force generated by this abutment when fitting the primary cup 20 having the projecting portions 24 projecting by a length longer than the preset length into the annular concave portion G, in the case of the primary cup 20 of the invention, however, since the direction of the displacement is a direction toward the clearance range C, and hence the displacement is absorbed by the clearance range C. Accordingly, a problem caused by the base portion 23 projecting toward the first inner wall surface 41 is inhibited and a problem caused by the contact of the base portion 23 with respect to the first inner wall surface 41 is inhibited, so that the fitting is facilitated without forcedly deforming the projecting portions 24 and the base portion 23.

In addition, by forming the projecting portions 24 integrally with the inner lip portion 21 as the protruded portion formed on the inner lip portion 21, the rigidity of the inner lip portion 21 is increased and, for example, even when the frictional force from the first piston 11 is applied in the direction to pull back the inner lip portion 21 when the first piston 11 is actuated, the projecting portions 24 inhibit the deformation of the inner lip portion 21 and hence the deterioration of the sealing properties does not occur. In addition, the projecting portions may be formed by utilizing the space between the inner lip portion and the outer lip portion effectively.

As mentioned above, according to the embodiment, by the setting of the base portion of the cup seal, the clearance range can be formed between the base portion and the first inner wall surface in a state in which the projecting portion and the second inner wall surface are in abutment with each other, and the abutting area of the base portion other than the area corresponding to the projecting portions is in abutment with the first wall surface.

Furthermore, according to the other embodiment, the partial abutting area of the base portion can be brought into abutment with the first inner wall surface by the setting of the cap shape and the setting of the shape of the first inner wall surface and the clearance area can be formed on the side of the outer periphery with respect to the abutting portion. Also, since the abutting portion is formed on the inner peripheral side of the base portion, the inner lip portion is formed to a position in the proximity to the first inner wall surface, so that the inner lip portion closes the communicating hole of the piston quickly at the time of the braking operation, so that reduction of the invalid stroke is realized.

What is claimed is:

1. A master cylinder comprising:
a cylinder body formed with an annular concave portion at a position surrounding a space where a piston is inserted so as to fit in the cylinder body, the piston being formed with a communication hole configured to communicate a pressure chamber in the interior of the piston and a reservoir on the outside of the piston;
an annular cup seal provided in the annular concave portion and configured to be fitted on the piston so as to be capable of moving relatively with respect to the piston, and the cup seal being provided at a position closing the communication hole in association with the actuation of the piston at the time of a braking operation, wherein
the annular concave portion includes a first inner wall surface on the upstream side in the direction of actuation of the master cylinder at the time of the braking operation, and a second inner wall surface opposing thereto,
the cup seal integrally includes: an inner lip potion coming into sliding contact with the piston, an outer lip portion arranged on the outer peripheral side of the annular concave portion, and a base portion arranged along the first inner wall surface, and is formed with projecting portions coming at projecting ends thereof into abutment with the second inner wall surface at a plurality of positions in the circumferential direction of the cup seal, and
the cup seal is provided in the annular concave portion in a mode in which clearance areas are formed between the first inner wall surface and the base portion at positions opposing abutting positions between the projecting portions and the second inner wall surface in a state in which the projecting portions are brought into abutment with the second inner wall surface and part of the base portion is brought into abutment with the first inner wall surface as an abutment area.

2. The master cylinder according to claim 1, wherein the base portion is formed with depressed portions separated from the first inner wall surface opposing the abutting positions between the projecting portions and the second inner wall surface as the clearance areas and a position of the base portion different from the depressed portion is formed on the base portion as the abutment area.

3. The master cylinder according to claim 1, wherein the inner peripheral portion located on the inner peripheral side of the base portion comes into abutment with the first inner wall surface as the abutment area, and the clearance range is formed between the base portion and the first inner wall surface on the side of the outer periphery of the base portion with respect to the inner peripheral portion thereof.

4. The master cylinder according to claim 1, wherein the first inner wall surface is formed into an inclined surface extending away from the second inner wall surface as it approaches the piston and the outer peripheral portion of the base portion located on the outer peripheral side is brought into abutment with the first inner wall surface as the abutment areas, whereby the clearance range is formed between the base portion on the inner peripheral side with respect to the outer peripheral portion and the first inner wall surface.

5. The master cylinder according to claim 1, wherein the projecting portions are formed in the inner lip portion as protruding portions formed on a surface of the inner lip portion opposing the outer lip portion so as to protrude therefrom.
